(19) United States
(12) Patent Application Publication
(10) Pub. No.: US 2012/0192106 A1
(43) Pub. Date: Jul. 26, 2012

(54) MULTIMEDIA AUTHORING TOOL

(75) Inventors: Alexander J. Kieft, Somerville, MA (US); Michael Kolowich, Sudbury, MA (US); Peter Russell Williams, Wayland, MA (US)

(73) Assignee: KNOWLEDGEVISION SYSTEMS INCORPORATED, Concord, MA (US)

(21) Appl. No.: 13/303,820

(22) Filed: Nov. 23, 2011

Related U.S. Application Data
(60) Provisional application No. 61/416,585, filed on Nov. 23, 2010.

(51) Int. Cl. G06F 3/048; G06F 15/16

(52) U.S. Cl. 715/800

(57) ABSTRACT

An apparatus and method of producing multiple panels for display on a single display device receives first and second data through a user interface. The first data relates to a first panel having first visual indicia and a first timeline, while, in a similar manner, the second data relates to a second panel having second visual indicia and a second timeline. The apparatus and method select a given time in both the first and second timelines, and coordinate, at least in part in a computer process, the first data with the second data to produce a multi-panel presentation. The multi-panel presentation has at least one instruction that causes at least a portion of at least one of the first panel and second panel to change size at the given time when displayed on a single display device.

### PRIORITY

This patent application claims priority from provisional U.S. patent application No. 61/416,585, filed Nov. 23, 2010, entitled, “PROGRAMMABLE EMPHASIS AND HIGHLIGHTING FOR SYNCHRONIZED ONLINE PRESENTATIONS,” and naming Alex Kieft, Michael Kolowich, and Peter Russell Williams as inventors, the disclosure of which is incorporated herein, in its entirety, by reference.

### FIELD OF THE INVENTION

The invention generally relates to multimedia displays and, more particularly, the invention relates to devices for producing multimedia displays.

### BACKGROUND OF THE INVENTION

With the growth of the broadband Internet, people are increasingly using multimedia to communicate and share online. Companies use multimedia to communicate with their employees, clients, customers, partners, suppliers, prospects, and other constituents. Individuals use multimedia for a wide variety of applications, such as selling property (e.g., a car, house, boat, or plane) or creating a compilation of photos and videos from a vacation. Using video, audio and graphics more effectively conveys information, engages the viewer, forms a more personal relationship and establishes the credibility of the presenter.

Conveying a story or concept is more effective when multiple senses are engaged. Most companies cannot afford the high production costs associated with creating these effects in a video production system. Video production is also inherently inflexible and difficult to revise or update.

### SUMMARY OF VARIOUS EMBODIMENTS

In accordance with one embodiment of the invention, an apparatus and method of producing multiple panels for display on a single display device receives first and second data through a user interface. The first data relates to a first panel having first visual indicia and a first timeline, while, in a similar manner, the second data relates to a second panel having second visual indicia and a second timeline. The apparatus and method select a given time in both the first and second timelines, and coordinate, at least in part in a computer process, the first data with the second data to produce a multi-panel presentation. The multi-panel presentation has at least one instruction that causes at least a portion of at least one of the first panel and second panel to change size at the given time when displayed on a single display device. The method and apparatus also cause storage of the multi-panel presentation in a persistent data storage device.

In response to a request to display the presentation, the method and apparatus also may retrieve the multi-panel presentation from the data storage device, and forward the retrieved multi-panel presentation toward the single display device for display on the display device. For example, the method and apparatus may forward the retrieved multi-panel presentation toward the single display device across a computer network. Among other things, either or both the first and second data can include one or more of text data, picture data, audio, and video data.

At the given time, the first panel may zoom in while the second panel zooms out. For example, the first panel may zoom in at a first rate while the second panel zooms out at a second rate that is proportional to the first rate. Moreover, the zooming can happen at multiple other times along the timelines. For example, the method and apparatus can select a plurality of additional times in both the first and second timelines, and coordinate, at least in part in a computer process, the first data with the second data to add a plurality of additional instructions to the multi-panel presentation. This plurality of additional instructions causes at least a portion of at least one of the first panel and second panel to change size at the additional times (when displayed on the single display device).

In response to receipt of a request to display the multi-panel presentation, the method and apparatus may retrieve the multi-panel presentation from the data storage device, and display the multi-panel presentation on the display device. At least a portion of at least one of the first panel and second panel automatically changes size at the given time (without manual intervention). After receipt of this request, however, the method and apparatus may receive manual instructions that cause the first panel and second panel to change size at times other than at the given time.

Some embodiments include a third panel for displaying a data stream of words. In addition, the third panel further has an associated search box for searching words within the data stream of words.

In accordance with another embodiment of the invention, an authoring tool for producing multiple panels for display on a single display device has an interface for receiving panel data. Among other things, the panel data includes 1) first data relating to a first panel having first visual indicia and a first timeline, and 2) second data relating to a second panel having second visual indicia and a second timeline. The tool also has a timing selector configured to select a given time in both the first and second timelines, and a synchronizer operatively coupled with the timing selector. The synchronizer coordinates, at least in part in a computer process, the first data with the second data to produce a multi-panel presentation having at least one instruction. Specifically, this at least one instruction causes at least a portion of at least one of the first panel and second panel to change size at the given time when displayed on a single display device. Finally, the tool also has a storage module operatively coupled with the synchronizer. The storage module is configured to cause storage of the multi-panel presentation in a persistent data storage device. For example, the storage module may forward, across a LAN, a WAN, a SAN, or the Internet, the presentation with instructions to store the presentation in a hard drive.

Illustrative embodiments of the invention are implemented as a computer program product having a computer usable medium with computer readable program code thereon. The computer readable code may be read and utilized by a computer system in accordance with conventional processes.

### BRIEF DESCRIPTION OF THE DRAWINGS

Those skilled in the art should more fully appreciate advantages of various embodiments of the invention from the following “Description of Illustrative Embodiments,” discussed with reference to the drawings summarized immediately below.

FIG. 1A schematically illustrates a multi-panel multi-media presentation;

FIG. 1B schematically illustrates a multi-panel multi-media presentation

FIG. 2 illustrates an embodiment of an enhanced multi-panel presentation;

FIGS. 3A and 3B show screen-captures of an embodiment of a multi-panel presentation at two different times;

FIGS. 4A-4C show screen-captures of an embodiment of a multi-panel presentation at three different times;

FIGS. 5A and 5B show screen-captures of an embodiment of a multi-panel presentation at two different times;

FIG. 6 schematically illustrates an embodiment of a multi-panel presentation with emphasized text;

FIGS. 7A and 7B show screen-captures of embodiments of multi-panel presentations;

FIG. 8 schematically illustrates a method of producing a multi-panel presentation;

FIGS. 9A-9H are screen-captures of embodiments of a number of user interfaces from an embodiment of a tool for producing multi-panel presentations;

FIG. 10 schematically illustrates a network for producing multi-panel presentations; and

FIG. 11 schematically illustrates a system for producing multi-panel presentations.

### DESCRIPTION OF ILLUSTRATIVE EMBODIMENTS

Illustrative embodiments present methods and devices for authoring presentations that allow the author to incorporate, integrate and coordinate multiple forms of content for display to a viewer. More specifically, the methods of various embodiments allow an author to emphasize a portion of the presentation with respect to one or more other portions of the presentation.

The methods are easy to use and give the author a variety options for engaging the viewer and emphasizing aspects of the message being communicated. Many of the available features may be used individually, or in combination with other figures within a presentation. Details of illustrative embodiments are discussed below.

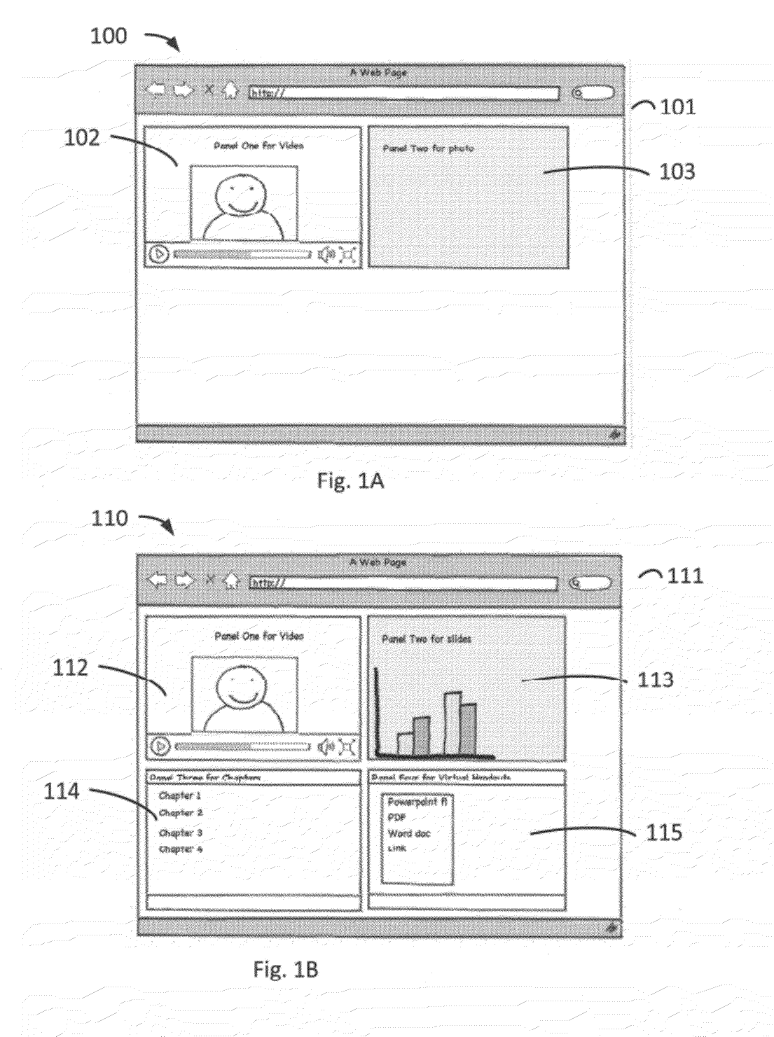

An example 100 of a multi-content a multimedia presentation is schematically illustrated in FIG. 1A, in which a display device 101 shows two panels 102 and 103 of content. As used herein and in any appended claims, the term “display device” (or “display” when used as a noun) means a device capable of displaying image data, such as a computer monitor or the screen of a mobile phone, for example. The term “panel” (or “window”) refers to a region within a presentation in which content, media or data is shown.

In FIG. 1A, a first panel 102 shows video content, while the other panel 103 shows a photograph. In this example, the panels 102 and 103 are of equal size.

Another example 110 of a multi-content a multimedia presentation is schematically illustrated in FIG. 1B, in which a display device 111 shows four panels 112, 113, 114 and 115 of content. In this example, panel 112 is again a video, while panel 113 shows a slide (e.g., a PowerPoint slide), panel 114 shows text identifying various chapters of the presentation, and panel 115 shows data representing a virtual hand-out.

A presentation using such panels may be able to deliver a message to a viewer, but the presentation might be enhanced if at least one of the panels 102 or 103 in FIG. 1A, or 112, 113, 114 or 115 in FIG. 1B (or more particularly, the content of at least one of the panels) could be emphasized or drawn to the viewer's attention.

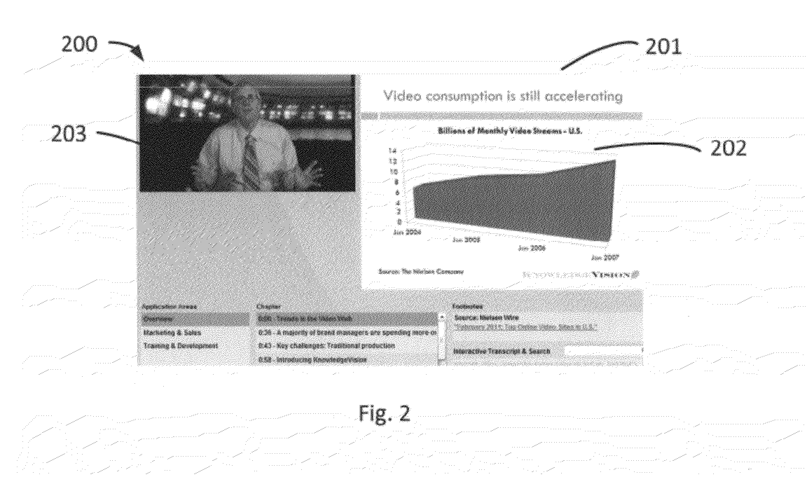

In another embodiment 200 illustrated in FIG. 2, a presentation 201 is enhanced by drawing the viewer's attention to a portion of the presentation, while not depriving the view of access to other portions of the presentation.

Specifically, the graphic in panel 202 is larger than the video in panel 203. The narrator in the video remains visible in panel 203, but the graphic in panel 203 is larger and more visible. As such, the viewer feels connected to the narrator but has a clear view of the graphic.

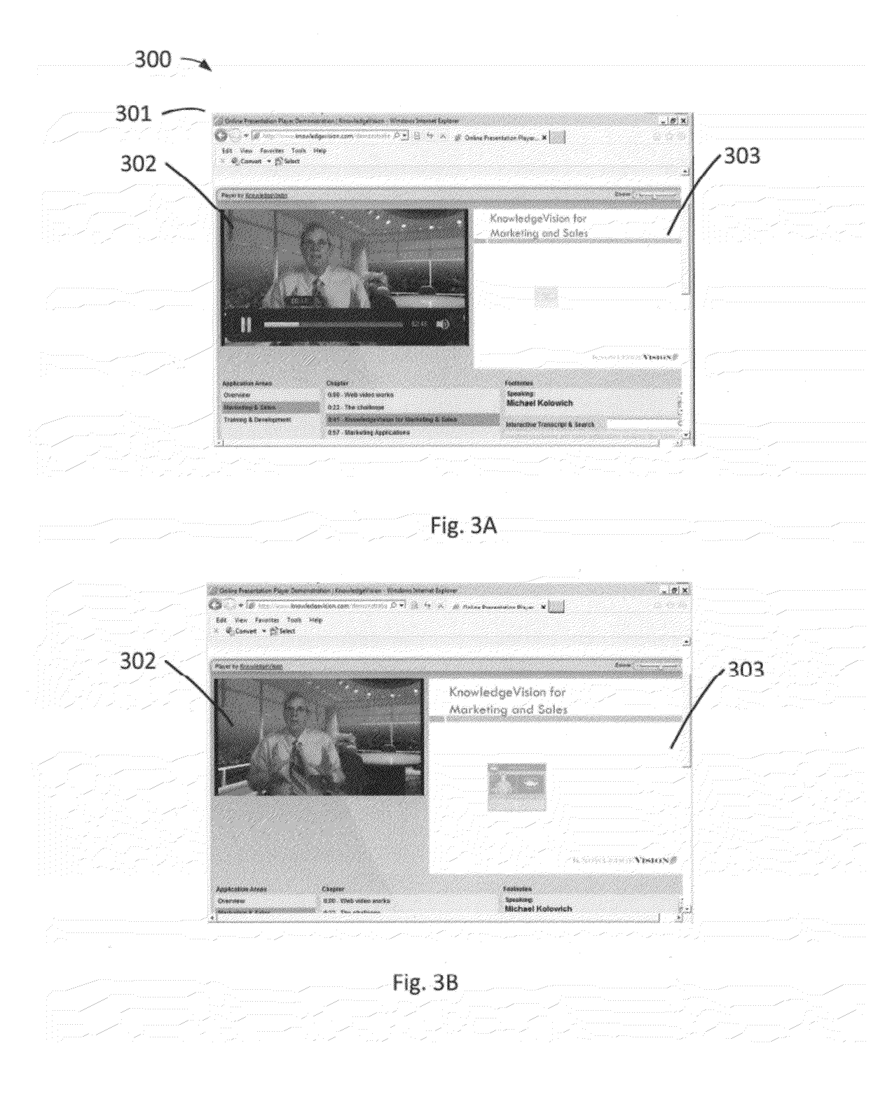

Another embodiment 300 is illustrated in FIGS. 3A and 3B, which shows two screen-captures of a presentation on a display 301 at two different times. The presentation initially started with two panels 302 and 303 of equal size (not shown). In this embodiment, panel 302 is a video of a speaker or narrator, while panel 303 is a PowerPoint slide. In this embodiment, the author of the presentation desired to emphasize the content of panel 303 over the content of panel 302. Therefore, in FIGS. 3A and 3B, the author caused panel 303 to enlarge (i.e., zoom in) and caused panel 302 to reduce in size (i.e., zoom out). As used herein and in any appended claims, the term “zoom” means to change the size of a visual image. For example, the size of a visual image may be determined by area, such as the area of a display device occupied by the image, as measured in square centimeters, for example. Alternately, the size of the image may be specified as a portion of the available display device, as measured as a percentage of available screen size, for example. To zoom the image means to increase (“zoom in”) or decrease (“zoom out”) the size of the image.

Similarly, the term “zoom rate” is a measure of the change of size of an image size over time. In some embodiments, zoom rates for two panels may be proportional. In some embodiments, a “proportional” zoom rate means that one panel zooms in and another panel zooms out in such a way that the sum of their widths remains constant. For example, in FIG. 3A, panel 302 and panel 303 have a combined width equal to the width of the display area (aside from a small gap in-between them). In FIG. 3B, the sizes of panels 302 and 303 have changed, but their combined width is still equal to the width of the display area.

While the embodiment of FIGS. 3A and 3B arrange panels horizontally, other embodiments may arrange panels in various ways. For example, another embodiment may arrange two or more panels vertically, in which case a “proportional” zoom rate means that the sum of the panels' heights would remain constant.

Alternately, in some embodiments a “proportional” zoom rate means that one panel zooms in and another panel zooms out in such a way that the sum of the two panel sizes remains substantially constant. For example, if a first panel occupies 100 square centimeters of a display device, and a second panel occupies 100 square centimeters of the display device, then if the first panel zooms out such that its area is reduced by 25 square centimeters (i.e., such that the first panel then occupies 75 square centimeters), then the second panel zooms in to increase its size by 25 centimeters (i.e., such that the second panel then occupies 125 square centimeters).

FIG. 3A illustrates a point in the zooming process in which panel 302 has begun to zoom out. As shown, panel 302 is slightly smaller than panel 303 at the moment of the screen capture in FIG. 3A. At a later moment, which may be only a fraction of a second later or could be any amount of time later, the size difference between the panels 302 and 303 is more pronounced. Specifically, panel 302 is now considerably smaller than panel 303. This has the effect of drawing the viewer's attention to the content of panel 303 at least because that panel is now more prominently shown on the display 301. In other words, panel 303 now occupies a larger portion of the available display area, and therefore is more likely to be seen by the viewer. In addition, the act of zooming one or more panels also creates motion on the display that tends to draw the viewer's attention. While some embodiments zoom two or more panels simultaneously, other embodiments may zoom panels sequentially, for example by zooming one panel out and then zooming another panel in.

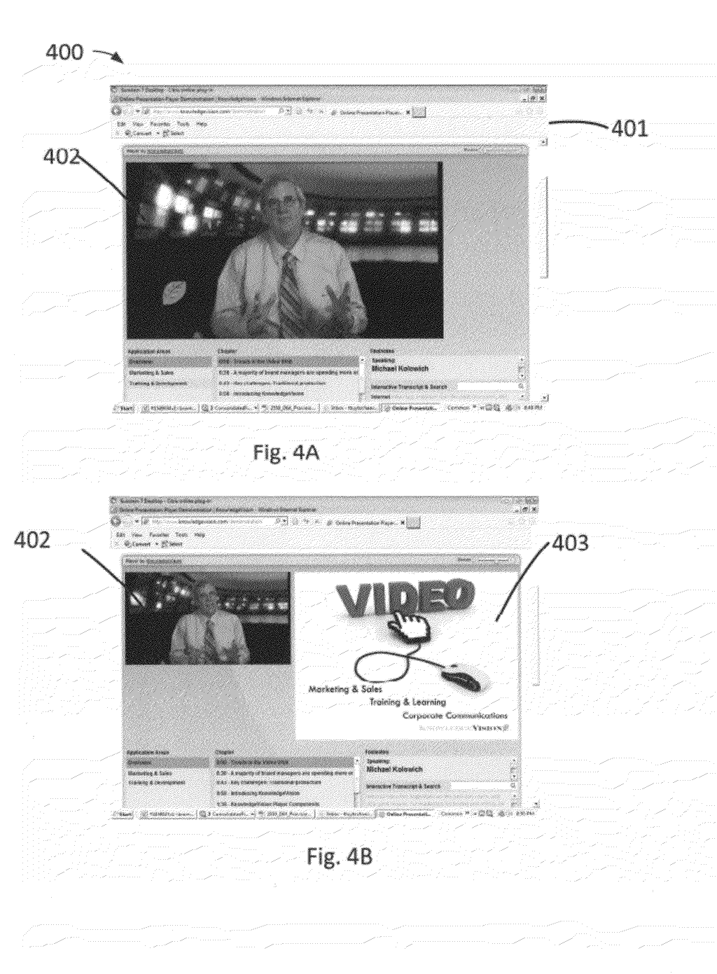

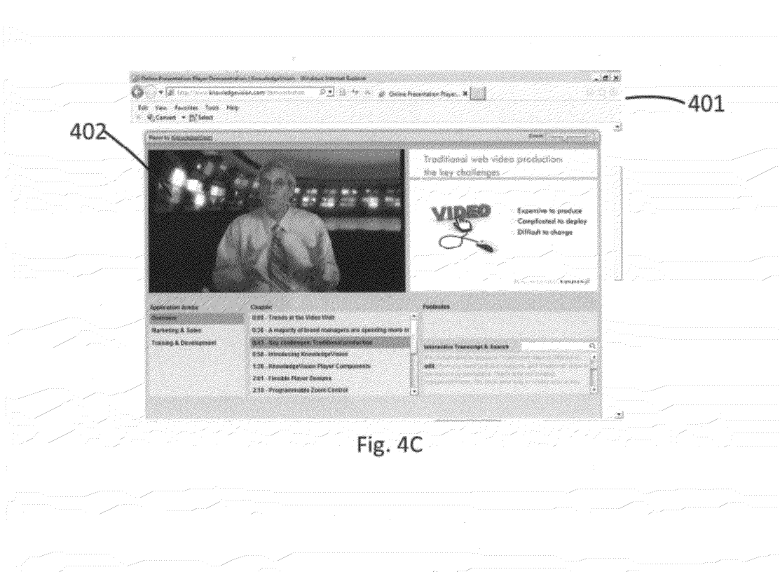

Another embodiment 400 is illustrated in FIGS. 4A and 4B. In FIG. 4A, a display 401 shows a single panel 402, which in this example is a video of a person narrating the presentation. At a later point in the presentation (i.e., a later point in time), panel 402 has zoomed out, and a panel 403 has appeared. At a different time, the relative sizes of the panels may change, as illustrated in FIG. 4C.

In these examples, panels may be introduced, removed or replaced, and their relative sizes may be changed, as determined by the presentation's author. Specifically, the author may define the behavior of the panels when creating the presentation. In addition, the content of a presentation may be cast into different format, with different panel behavior, at any time after the content of the presentation is available.

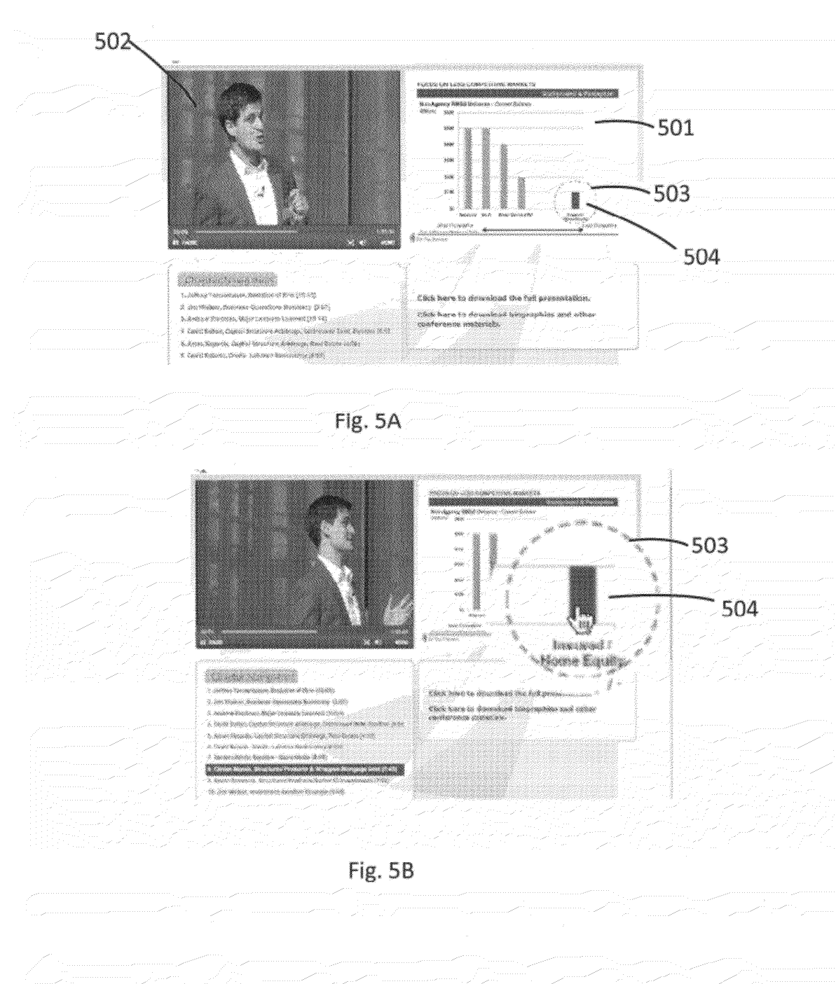

Another way to enhance a presentation is to visually enhance a portion of the content of a panel, even if the remainder of that content is not enhanced, or not enhanced as much. For example, FIG. 5A illustrates a display 501 showing two panels 502 and 503, which are approximately the same size. Panel 502 shows video of the presenter, while panel 503 shows a chart of data being described by the presenter. In this example, the author of the presentation desires to emphasize a portion of the chart 504. As such, the author has programmed the presentation to magnify a portion of the chart, as illustrated in FIG. 5B. A circle 503 around the portion of the chart 504 to be magnified in included in FIG. 5A, and provides a visual cue to the viewer that the encircled portion will be (or has been) enhanced by magnification, as illustrated in FIG. 5B.

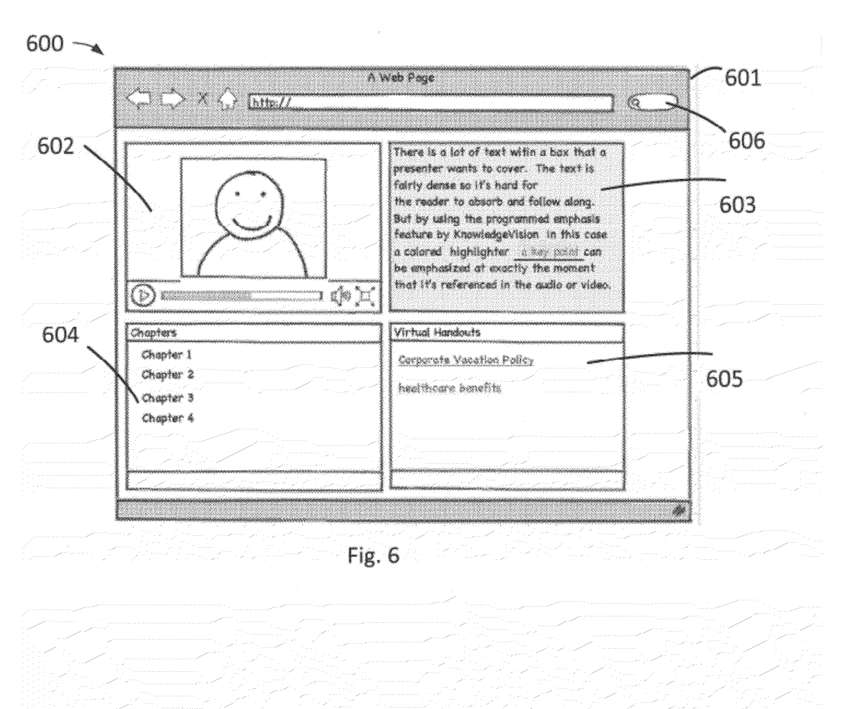

Yet another example 600 is presented in FIG. 6, in which a display 601 shows four panels, 602-605. Panel 602 is video of a presenter, while panel 603 includes the text of the presenter's speech. To further enhance the presentation, each word (or phrase) of the speech is highlighted (e.g., bolded or presented against a background color, for example) as that word (or phrase) is spoken in the video. For example, in FIG. 6, the words “a key point” are highlighted by a shaded box in area 603. For purposes of clarity, those words are also underlined in FIG. 6, although two forms of emphasis are not required. Some embodiments include a search box 606 representing a search engine, to allow a viewer to search the text of the presenter's speech. Additional embodiments allow a viewer to click on a word in that text and cause the presentation to jump to that point in the video.

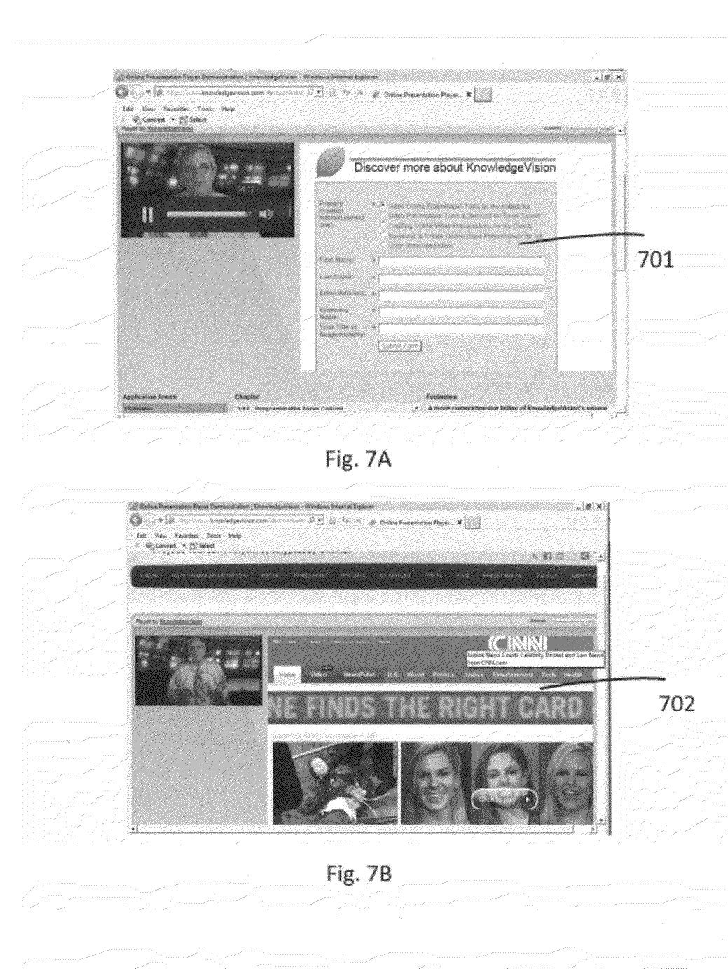

Although several types of data have been discussed above in connection with various panels, the content of the various panels may be limited only by the author's imagination. For example, other content that may be presented in a panel include viewer feedback questionnaires 701 as in FIG. 7A, and live web page feeds 702, as in FIG. 7B, to name but a few.

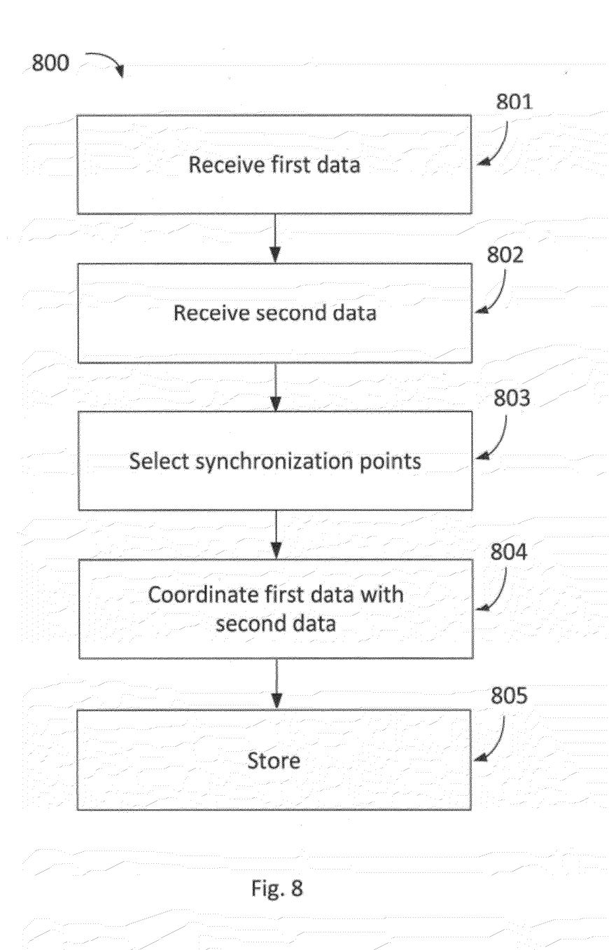

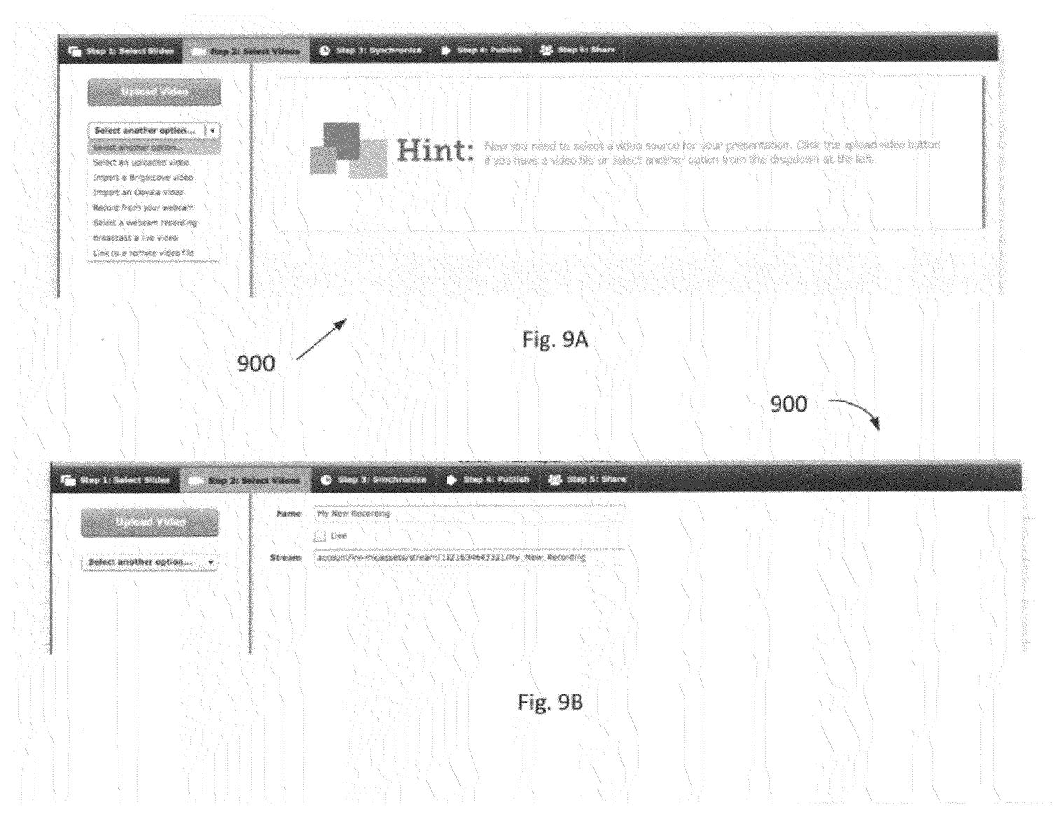

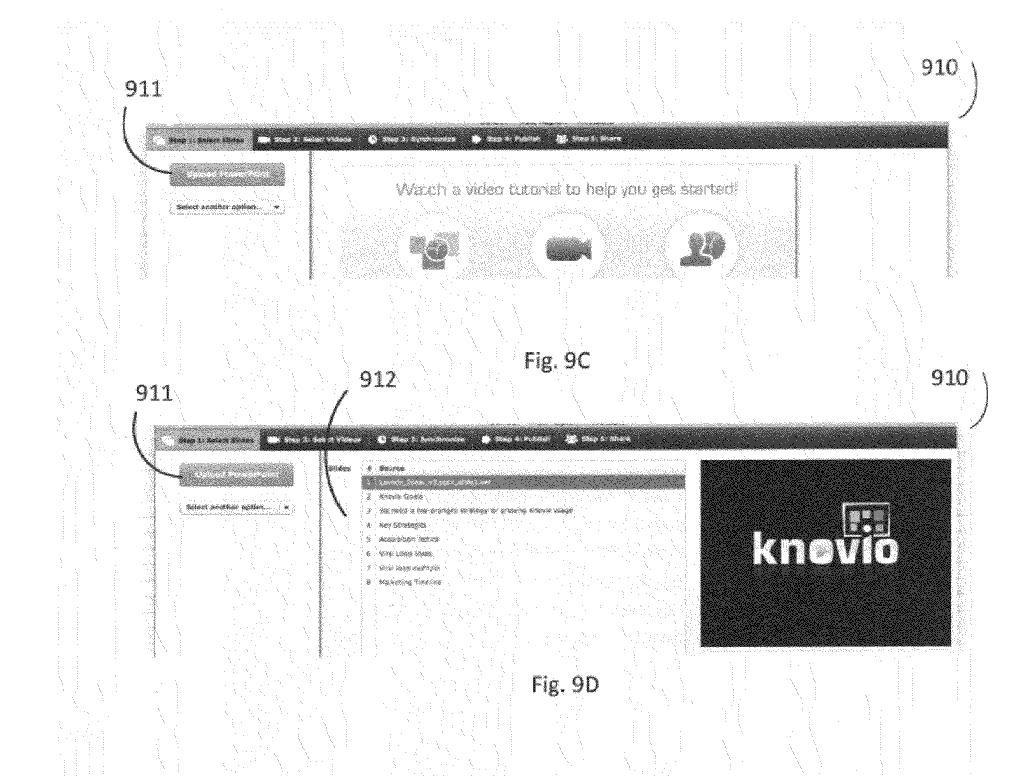

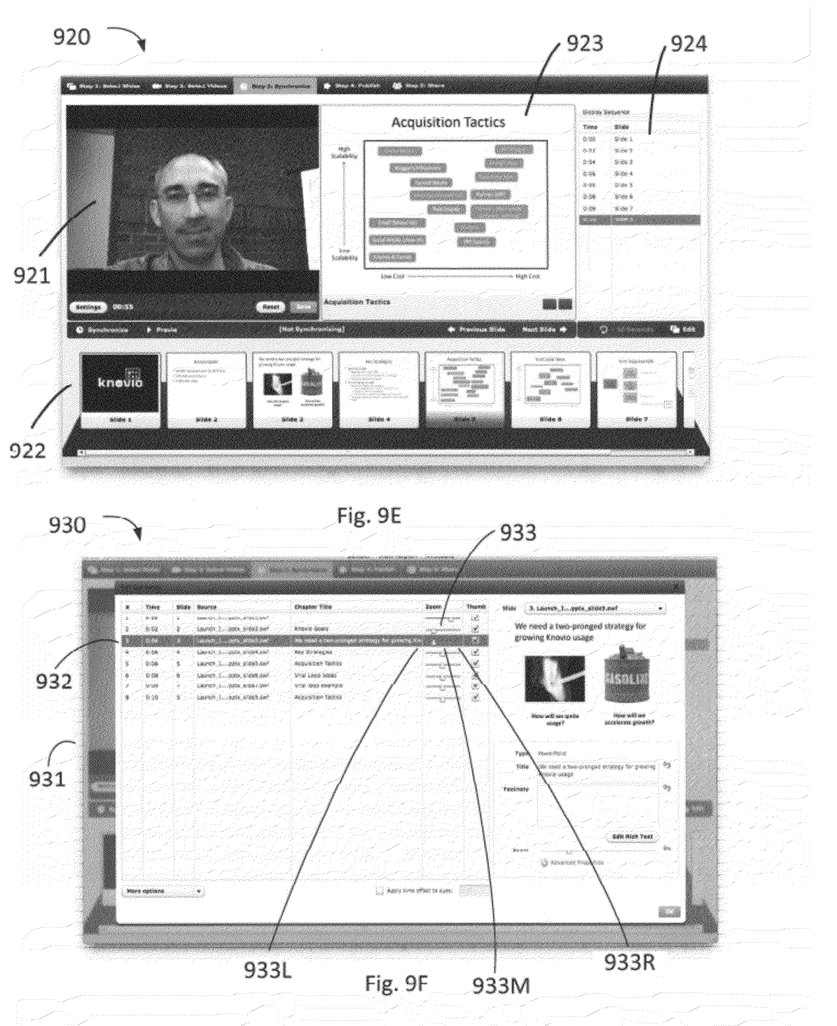

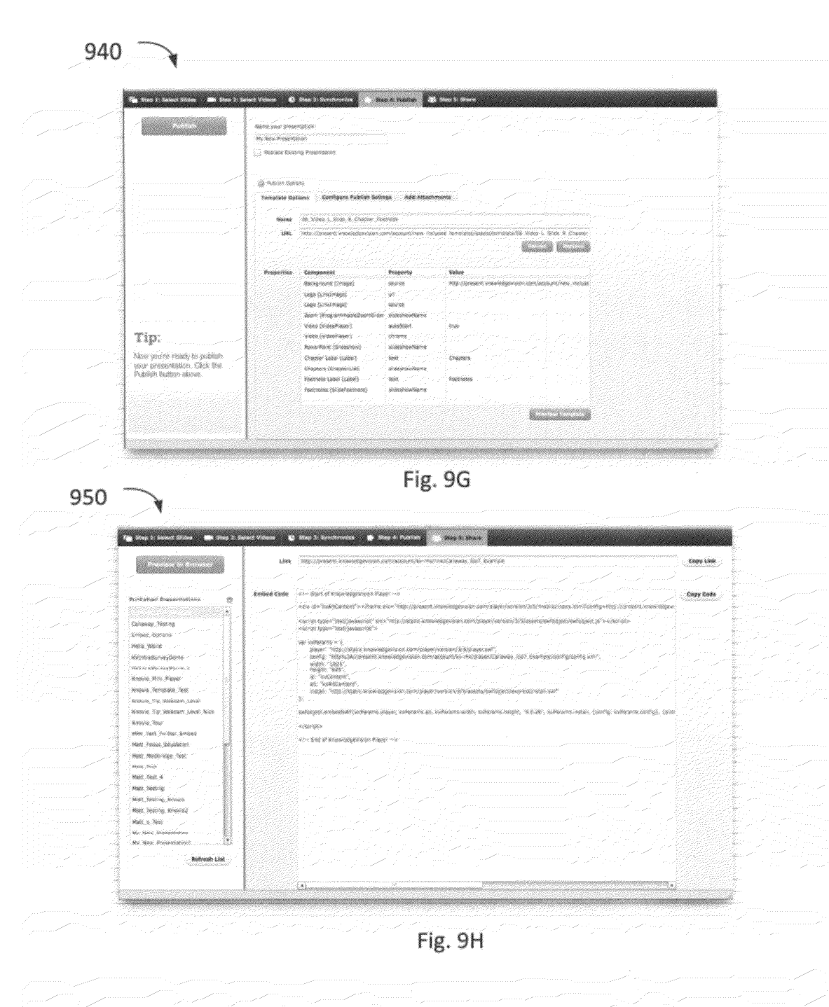

FIG. 8 shows a method 800 of producing multiple panels for display in accordance with illustrative embodiments. FIGS. 9A-9H show various user interfaces modules of an authoring tool, with the understanding that embodiments of methods are not limited by the embodiments of the authoring tool, and embodiments of authoring tools are not limited by embodiments of methods.

The method 800 begins with step 801 by receiving, through a user interface, first data relating to a first panel having first visual indicia and a first timeline. The first data may be a segment of video, in a format such as MP4, Windows Media, or Quicktime, to name but a few. As used herein and in any appended claims, the term “visual indicia” means a graphic image, such as a video image, a photograph, text, or a logo, for example. The first data may also include a segment of audio, in a format such as MP3 for example. A segment of video or audio inherently has a timeline from the beginning to the end of the segment.

FIGS. 9A and 9B show one embodiment 900 of a user interface in an authoring tool configured for receiving first data. If the first data is a video, for example, in some embodiments the first data may be selected from among one or more pre-recorded videos stored, for example, on an author's computer, or on a remote storage device. In some embodiments, such video may be captured from a camera on the author's computer (e.g., a web cam, for example), or from another camera. Alternately, in some embodiments the selected first data may be a link to a live video feed, so that the presentation, when viewed by a viewer at a later time, will see video from the selected source that is essentially live at the time of viewing (as opposed to recorded at or prior to the time of authoring the presentation).

The method 800 also includes receiving second data relating to a second panel having second visual indicia (step 802). The second data may be slides, such as a set of one or more PowerPoint slides, or other media. In some embodiments, the second data may have its own timeline. For example, the second data may be a segment of video or audio that has an inherent timeline.

FIGS. 9C and 9D illustrate an embodiment 910 of a user interface for receiving second data. An author may click on the “Upload PowerPoint” button 911 as shown in FIG. 9C, and may then select the second data from one or more PowerPoint files 912 as shown in FIG. 9D. In some embodiments, clicking on the “Upload PowerPoint” button may open a navigation pane to allow the author to navigate the author's computer, or any other network accessible to the author, to locate a desired second data.

Some embodiments may include selecting or receiving additional data (e.g., third data, fourth data, etc.) for display in corresponding additional panels, in ways similar to those described above. Such additional data may include text, or chapter information as illustrated above, or other data that the author desires to incorporate into the presentation. Also, the selecting or receiving of data may be performed in any order. For example, for a presentation in which the first data is video and the second data is one or more PowerPoint slides, some embodiments may receive a PowerPoint data prior to receiving video data.

After receiving the first and second data, step 803 coordinates the second data to the first timeline of the first data, at least in part in a computer process, to produce a multi-panel presentation. More specifically, this step produces a multi-panel presentation that causes at least a portion of at least one of the first panel and second panel to change size at the given time when displayed on a single display device. To that end, the presentation has instructions that, when executed by a computing device, produces this relative panel sizing change as described above.

In some embodiments, this process of coordinating involves both synchronizing the second data to the timeline of the first data, and specifying the sizes of the panels used to display those data. More particularly, synchronizing the second data to the first timeline couples the first data to the second data at one or more points in time. Thus, when the presentation is played, that coupling causes at least a portion of at least one of the first panel and second panel to change size at the given time when displayed on a single display device. Prior figures discussed above provide a number of examples of how this looks to the ultimate viewer.

FIG. 9E shows one embodiment of a user interface 920 for synchronizing the second data to the first timeline. In this embodiment, the video (first data) is played in a panel 921, while a number of PowerPoint slides 922 are displayed nearer the bottom of user interface screen. As the video plays, the interface receives input from the author to synchronize one or more of the slides to the video. The author may do this, for example, by clicking on a desired slide from the number of slides 922 at the desired point in the video.

For example, the “Display Sequence” box 924 indicates the time-based association with slides to the video timeline. In this example, as the video begins in the first panel 921, slide 1 will be shown in another panel 923 in the presentation. Two seconds into the video, slide 1 is replaced in the second panel 923 by slide 2. To establish this synchronization, in some embodiments the author watching the video may simply click on the desired slide at the desired time. As indicated in box 924 in FIG. 9E for example, the author has clicked on slide 2 at 2 seconds, slide 3 at 4 seconds, and slide 4 at 6 seconds, and the interface has received this input. Note that the slides need not be selected in sequence, and can be used repeatedly. For example, slide 5 appears at 6 seconds and then again at 10 seconds, while slides 6 and 7 appear in-between those times.

Some embodiments included the ability to synchronize a first timeline to another timeline—e.g. a “second timeline” in a second data. In such an embodiment, the second timeline may be synchronized to the first timeline simply by specifying the time at which the second data begins to play (i.e., the start time of the second data) relative to the start time of the first data. In some embodiments, one of the second data may further be paused, or started and stopped, relative to the first timeline.

In yet other embodiments, the first timeline and second timeline may be synchronized differently at disparate points. In other words, the synchronization between the first time and the second time need not remain fixed, and need not be determined exclusively by their respective start times. For example, the playback of second data may begin at the start time of the first data, or at some time offset from the first start time. Later, the playback second data may jump to a second point in the second timeline. In such an embodiment, the images 922 shown in FIG. 9G may be frames of video in the second data, for example, and the display sequence in box 924 may indicate where the playback of the second data should start, stop or pause, and where in the second data (e.g., at which frame) such playback should begin or resume.

Next, the method 800 may coordinate the data (e.g., first data, second data, and other user input, etc.) at step 804. Coordinating the data includes adding instructions, or markers, to dictate the zoom behavior of the panels.

FIG. 9F shows an embodiment of a user interface 930 configured to receive data to coordinate the zooming of panels. In that figure, the “Display Sequence” data mentioned above is shown in one portion 931 of the screen, and each line of the sequence (e.g., line 932) has an associated slider 933. The slider 933 is configured to receive author input to define the relative sizes of the video panel and the panel showing the selected PowerPoint slide. Such input may be described as an “instruction” defining the panel sizing

For example, in some embodiments having a video panel and a PowerPoint panel, if the slider 933 is placed in the middle 933M of its range, the two panels will be of equal size. If the slider 933 is moved toward the left end 933L of its range, the video panel will be displayed larger than the PowerPoint panel, while if the slider 933 is moved toward the right end 933R of its range, the PowerPoint panel will be displayed larger than the video panel. In general, the further the slider is from the middle 933M of its range, the greater the size difference in the panels.

Next, the step 805 causes storage of the multi-panel presentation in a persistent data storage device. As used herein and in any appended claims, the term “persistent data storage device” means a device capable of providing non-transient storage of data. The memory may be computer memory as commonly known, or other storage media, including non-volatile media such as a CD-ROM or flash memory drive, for example.

FIG. 9G shows one embodiment of a user interface 940 configured to initiate the storage process. In some embodiments, the received data and other author input may simply be stored in a memory for later use. Some embodiments perform a “publication” step as part of the storage process. To that end, FIG. 9G shows one embodiment of a user interface 940 configured to initiate the publication process. Among other things, publication may process the first data, second data, and coordination instructions to produce a recorded multi-panel presentation that can be played in a media player, such as a web browser. When played, the presentation displays the first data and second data (and other data, if any) in the ways specified by the author, including the synchronized display of the video and changing slides, and zooming of various panels on a single display device.

In some embodiments, the storage process receives a selection from the author of a template for displaying the received data. For example, consider an authored presentation that includes first data in the form of video of a presenter narrating the presentation, second data in the form of PowerPoint slides corresponding to the narration, and third data in the form chapter headings of portions of the presentation, and fourth data in the form of virtual handouts, as in FIG. 1B. In one embodiment, a template may include four panels—one corresponding to each of the first data, second data, third data and fourth data. When published, each panel will display its corresponding data, and the panels will zoom in and/or zoom out as determined by the data received in the coordination step.

A given presentation may be used with a variety of templates. For example, the presentation described above has a first, second, third and fourth panel, but could still be used with a 2-panel template. For example, a 2-panel template may display only the first and second data, but the third and fourth data is simply ignored or omitted from the final presentation.

Once complete, the presentation may be played in a manner similar to the playing of any audio, visual, or multimedia matter. Indeed, during the recording process, the author may preview the presentation. A user interface 950 for previewing a publication is illustrated in FIG. 9H, for example. At some other time, a viewer could play the presentation on a computer, for example.

In some embodiments, an authoring tool or system for creating multi-panel presentations, the data that populates a presentation, templates, author inputs, and a presentation player may all reside on a single system, such as a single computer.

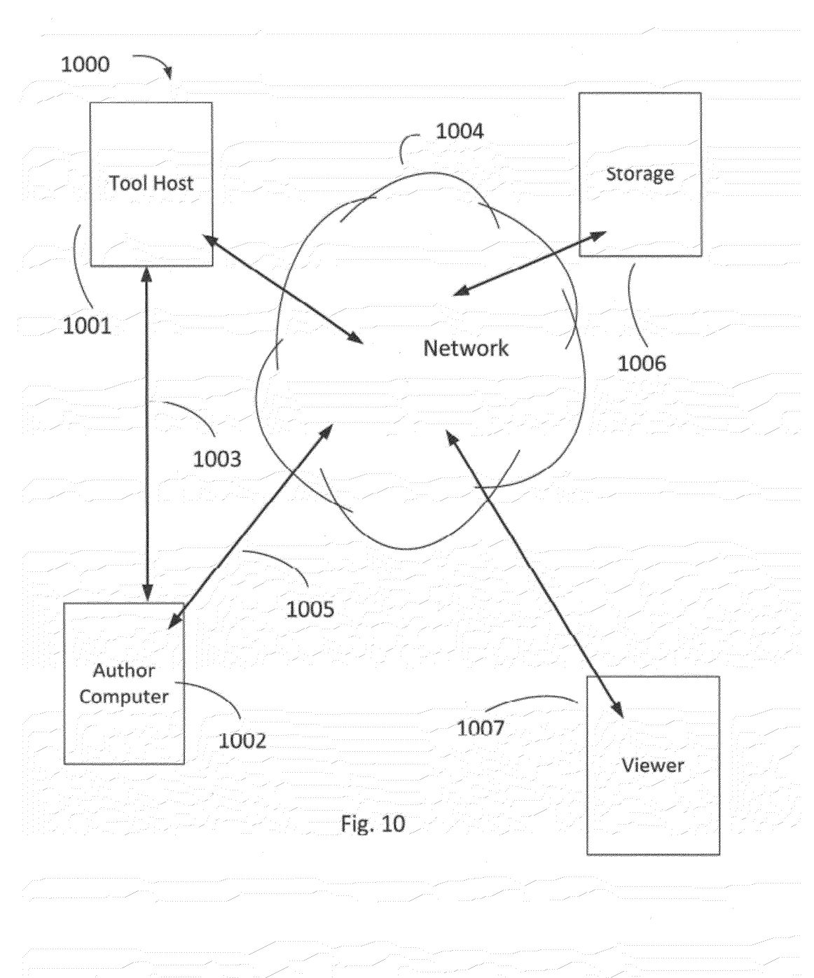

In other embodiments, various components may reside on several computers, which computers may be in communication with one other via communication links, or a computer network such as the Internet for example. One such embodiment 1000 is schematically illustrated in FIG. 10. An embodiment of an authoring tool resides on a first computer (or host) 1001, and may be accessed by an author working on a second computer 1002.

The second computer 1002 may access the authoring tool via a link 1003 to the first computer 1001, or via a computer network 1004 (which may be LAN or WAN, or the Internet, for example) via a link 1005. Indeed, any of the devices (1001, 1002, 1006 and 1007) illustrated in FIG. 10 may be coupled to one or more of the other devices by individual links (such as link 1003 for example) or via a network 1004, although only one such link (1003), and one such network link (1005) are schematically illustrated in FIG. 10.

The tool may run on the host 1001, or may download and run on the author's computer 1002.

A presentation may be stored on a storage medium 1006 and may be accessed by a viewer at another computer 1007. In some embodiments, a player to play the presentation resides on viewer computer 1007, in which case the presentation may be downloaded in its entirety from storage medium 1007 to viewer computer 1007. In other embodiments, however, the presentation may be sent from storage medium 1006 to viewer computer 1007 in a data transmission (e.g., streamed) so that the viewer computer 1007 can play the presentation as the data arrives. In yet other embodiments, the player resided on the storage medium 1006, which plays the presentation and sends the video and audio to the viewer computer 1007, such that the viewer computer simply acts as a display device.

The presentation may be stored on a data storage device (e.g., a first computer or host computer) 1001 and displayed on that data storage device, or on a viewer's computer having a single display device (e.g., a client) 1002. In some embodiments, a client computer 1002 may be coupled to the data storage device 1001 over a network 1003, such as a computer network or local area network (i.e., a LAN), or over another network, such as the Internet for example, as schematically illustrated in FIG. 10. A viewer at client 1002 may initiate the playback process by sending a request to display the presentation to the data storage device 1001. Upon receipt of the request, the data storage device retrieves the presentation and forwards the presentation to the client display device for display on that display device. Some embodiments may forward the entire presentation for display on the display device, so that the client has the entire presentation and plays the presentation (i.e., displays it on the client's display device) using a local presentation player. Other embodiments, however, may transmit data representing the presentation over time to the client for display on the display device, such that a player on the client displays the presentation as the data arrives.

Some embodiments include as part of the presentation a viewer interface that allows the viewer to manually adjust the size of one or more panels during playback. Such viewer input overrides the pre-programmed zoom instructions crated by the presentation's author that cause the panels to change size automatically when the presentation is played (i.e., without manual intervention). Some embodiments may also include a “return to presentation” input that allows a user to return the presentation to the behavior programmed by the author, after the viewer has manually overridden it.

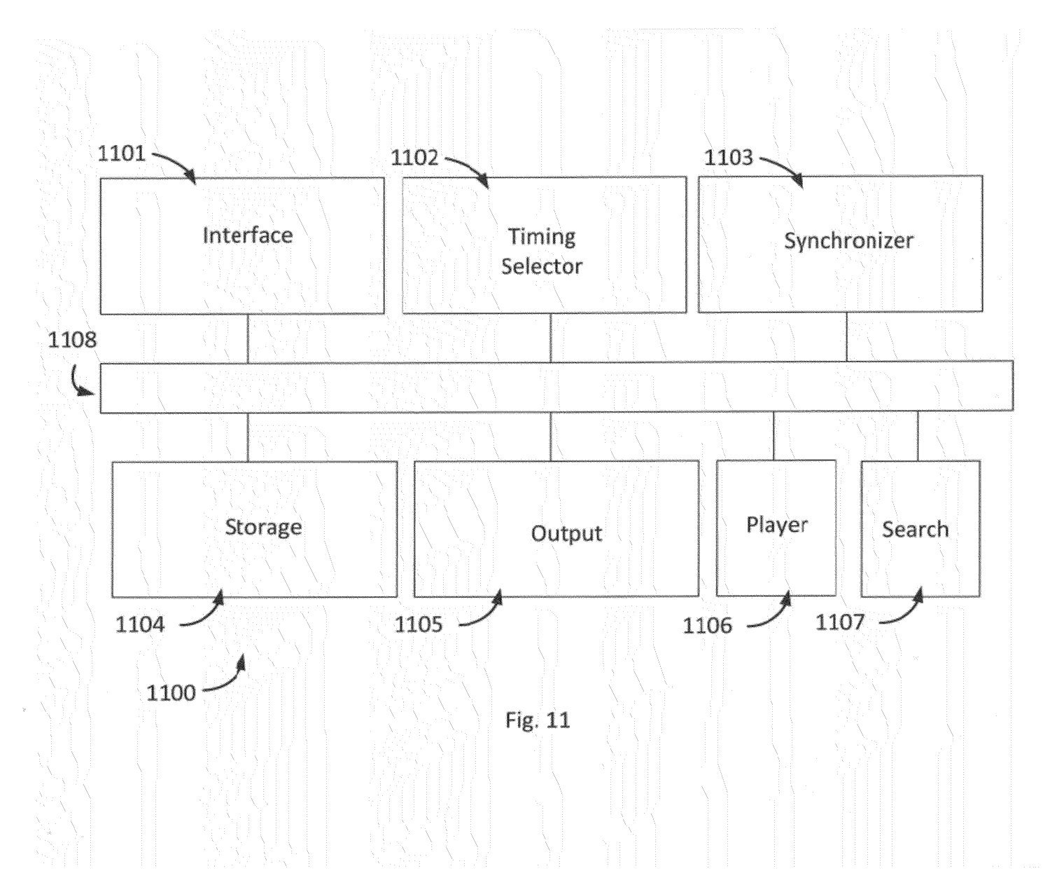

FIG. 11 schematically shows a block diagram of a system 1100 for producing multi-panel presentations on a single display device as discussed above. The system 1100 includes a number of functional modules that each may be combined with other modules, or separated as specified by those in the art. The modules can communicate by any number of means, such as through a common bus (1108), or other interconnect apparatus. The common bus 1108 of FIG. 11 thus merely is illustrative and not intended to limit various embodiments of the invention. The various modules in this system are configured to provide the functionality as described above.

The system 1100 includes interface module 1101 that provides an interface to receive the above noted author panel data, and a timing selector module 1002 configured to receive, from an author, an instruction selecting a given time in the first timeline. Among other things, as noted above, this panel data may include first data relating to a first panel having first visual indicia and a first timeline, and second data relating to a second panel having second visual indicia (an in some embodiments a second timeline).

A synchronizer module 1003 operatively coupled with the timing selector coordinates, at least in part in a computer process, the first data with the second data to produce a multi-panel presentation. As noted above, the multi-panel presentation (which may also be known as a multi-panel data stream) has at least one instruction that causes at least a portion of at least one of the first panel and second panel to change size at the given time when displayed on a single display device. As suggested above with respect to FIG. 8 and other figures, the synchronizer module 1003 can coordinate many different times along the timeline and thus, is not limited to coordinating a single time between different data types (e.g., a video and a PowerPoint presentation).

A storage module 1004 operatively coupled with the synchronizer causes storage of the multi-panel presentation in a persistent data storage device. In some embodiments, the storage module simply stores the received data and other author input. In other embodiments, the storage the module may be configured to receive an author's selection of a template as described above, and/or may be configured to perform the publication process as described above. The storage module 1004 may have persistent local storage, or merely have logic that causes storage of the presentation on some (other) memory device.

Some embodiments also have an output module 1005 configured to forward the presentation from the persistent data storage device to a remote devices, such as a client as described above for example, and/or a player 1106 configured to retrieve the presentation (i.e., a multi-panel data stream) from the persistent data storage device and forward the retrieved multi-panel presentation toward a single display device for display on the display device. A search module 1107 also may cooperate with the other modules to facilitate searching of certain text within a presentation.

Various embodiments of the invention may be implemented at least in part in any conventional computer programming language. For example, some embodiments may be implemented in a procedural programming language (e.g., “C”), or in an object oriented programming language (e.g., “C++”). Other embodiments of the invention may be implemented as preprogrammed hardware elements (e.g., application specific integrated circuits, FPGAs, and digital signal processors), or other related components.

In an alternative embodiment, the disclosed apparatus and methods may be implemented as a computer program product for use with a computer system. Such implementation may include a series of computer instructions fixed either on a tangible medium, such as a non-transitory computer readable medium (e.g., a diskette, CD-ROM, ROM, or fixed disk). The series of computer instructions can embody all or part of the functionality previously described herein with respect to the system.

Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies.

Among other ways, such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). Of course, some embodiments of the invention may be implemented as a combination of both software (e.g., a computer program product) and hardware. Still other embodiments of the invention are implemented as entirely hardware, or entirely software.

Although the above discussion discloses various exemplary embodiments of the invention, it should be apparent that those skilled in the art can make various modifications that will achieve some of the advantages of the invention without departing from the true scope of the invention.

What is claimed is:

1. A method of producing multiple panels for display on a single display device, the method comprising:
receiving, through a user interface, first data relating to a first panel having first visual indicia and a first timeline;
receiving second data relating to a second panel having second visual indicia;
selecting a given time in the first timeline;
coordinating, at least in part in a computer process, the first data with the second data to produce a multi-panel presentation, the multi-panel presentation having at least one instruction that causes at least a portion of at least one of the first panel and second panel to change size at the given time relative to the first timeline of the first data when displayed on a single display device; and
causing storage of the multi-panel presentation in a persistent data storage device.

2. The method as defined by claim 1 further comprising:
receiving a request to display the multi-panel presentation;
retrieving the multi-panel presentation from the data storage device; and
forwarding the retrieved multi-panel presentation toward the single display device for display on the display device.

3. The method as defined by claim 2 wherein forwarding comprises forwarding the retrieved multi-panel presentation toward the single display device across a computer network.

4. The method as defined by claim 1 wherein either or both the first and second data can include one or more of text data, picture data, and video data.

5. The method as defined by claim 1 wherein at the given time, the first panel zooms in while the second panel zooms out.

6. The method as defined by claim 5 wherein the first panel zooms in at a first rate and the second panel zooms out at a second rate, the first and second rates being generally proportional.

7. The method as defined by claim 1 further comprising:
selecting a plurality of additional times in the first timeline; and
coordinating, at least in part in a computer process, the first data with the second data to add a plurality of additional instructions to the multi-panel presentation, the plurality of additional instructions causing at least a portion of at least one of the first panel and second panel to change size at the additional times relative to the first timeline when displayed on the single display device.

8. The method as defined by claim 1 further comprising:
receiving a request to display the multi-panel presentation;
retrieving the multi-panel presentation from the data storage device; and
displaying the multi-panel presentation on the display device, at least a portion of at least one of the first panel and second panel automatically changing size at the given time without manual intervention.

9. The method as defined by claim 8 further comprising:
receiving manual instructions causing the first panel and second panel to change size at times other than at the given time.

10. The method as defined by claim 1 further comprising a third panel for displaying a data stream of words, the third panel further having an associated search box for searching words within the data stream of words.

11. The method as defined by claim 1 wherein at least one of the first data and second data includes audio data.

12. An authoring tool for producing multiple panels for display on a single display device, the authoring tool comprising:
an interface for receiving panel data, the panel data including first data relating to a first panel having first visual indicia and a first timeline, and second data relating to a second panel having second visual indicia;
a timing selector configured to select a given time in the first timeline;
a synchronizer operatively coupled with the timing selector, the synchronizer coordinating, at least in part in a computer process, the first data with the second data to produce a multi-panel presentation, the multi-panel presentation having at least one instruction that causes at least a portion of at least one of the first panel and second panel to change size at the given time when displayed on a single display device; and
a storage module operatively coupled with the synchronizer, the storage module being configured to cause storage of the multi-panel presentation in a persistent data storage device.

13. The authoring tool as defined by claim 12 wherein the storage module comprises an output for forwarding the multi-panel presentation toward a remote device.

14. The authoring tool as defined by claim 12 further comprising:
a player configured to retrieve the multi-panel presentation from the data storage device and forward the retrieved multi-panel presentation toward the single display device for display on the display device.

15. The authoring tool as defined by claim 14 wherein the player is configured to forward the retrieved multi-panel presentation toward the single display device across a computer network.

16. The authoring tool as defined by claim 12 wherein at the given time when being displayed by the single display device, the first panel zooms in while the second panel zooms out.

17. The authoring tool as defined by claim 16 wherein the first panel zooms in at a first rate and the second panel zooms out at a second rate, the first and second rates being generally proportional.

18. The authoring tool as defined by claim 12 wherein the timing selector is configured to select a plurality of additional times in the first timeline and the synchronizer is configured to coordinate, at least in part in a computer process, the first data with the second data to add a plurality of additional instructions to the multi-panel presentation, the plurality of additional instructions causing at least a portion of at least one of the first panel and second panel to change size at the additional times when displayed on the single display device.

19. The authoring tool as defined by claim 12 further comprising a search engine for searching words in the multi-panel presentation.

20. A computer program product for use on a computer system for producing multiple panel for display on a single display device, the computer program product comprising a non-transitory tangible computer usable medium having computer readable program code thereon, the computer readable program code comprising:
program code for receiving, through a user interface, first data relating to a first panel having first visual indicia and a first timeline;
program code for receiving second data relating to a second panel having second visual indicia;
program code for selecting a given time in the first timeline;
program code for coordinating, at least in part in a computer process, the first data with the second data to produce a multi-panel presentation, the multi-panel presentation having at least one instruction that causes at least a portion of at least one of the first panel and second panel to change size at the given time when displayed on a single display device; and
causing storage of the multi-panel presentation in a persistent data storage device.

21. The computer program process as defined by claim 20 further comprising:
program code for receiving a request to display the multi-panel presentation;
program code for retrieving the multi-panel presentation from the data storage device; and
program code for forwarding the retrieved multi-panel presentation toward the single display device for display on the display device.

22. The computer program process as defined by claim 21 wherein the program code for forwarding comprises program code for forwarding the retrieved multi-panel presentation toward the single display device across a computer network.

23. The computer program process as defined by claim 20 wherein at the given time, the first panel zooms in while the second panel zooms out when displayed by the single display device.

24. The computer program process as defined by claim 23 wherein, when displayed by the single display device, the first panel zooms in at a first rate and the second panel zooms out at a second rate, the first and second rates being generally proportional.

25. The computer program process as defined by claim 20 further comprising:
program code for selecting a plurality of additional times in the first timeline; and
program code for coordinating, at least in part in a computer process, the first data with the second data to add a plurality of additional instructions to the multi-panel presentation, the plurality of additional instructions causing at least a portion of at least one of the first panel and second panel to change size at the additional times when displayed on the single display device.

26. The computer program process as defined by claim 25 further comprising:
program code for receiving manual instructions causing the first panel and second panel to change size at times other than at the given time.

27. The computer program process as defined by claim 20 further comprising a program code for producing a third panel for displaying a data stream of words, the third panel further having program code for producing an associated search box for searching words within the data stream of words.
